(19) United States
(12) Patent Application Publication
(10) Pub. No.: US 2024/0378498 A1
(43) Pub. Date: Nov. 14, 2024

(54) MODULE-BASED PREFABICATED ARTIFICIAL INTELLIGENCE DEVELOPMENT SYSTEM

(71) Applicant: Korea University of Technology and Education Industry-University Cooperation Foundation, Cheonan-si (KR)

(72) Inventors: Won Tae KIM, Cheonan-si (KR); Young Jin Kim, Cheongju-si (KR); Han Jin Kim, Cheongju-si (KR)

(21) Appl. No.: 18/448,181

(22) Filed: Aug. 11, 2023

(30) Foreign Application Priority Data
May 10, 2023 (KR) 10-2023-0060729

(51) Int. Cl. G06N 20/00

(52) U.S. Cl. CPC G06N 20/00

(57) ABSTRACT

A module-based prefabricated artificial intelligence development system may be provided.

The system according to an embodiment of the present disclosure may include: an adaptive artificial intelligence development unit; and an AI module hub, wherein the adaptive artificial intelligence development unit comprises: analysis unit configured to obtain adaptive autonomous agent requirement information and receive an AI topology and AI modules corresponding to the adaptive autonomous agent requirement information from the AI module hub; an assembly unit configured to generate a candidate artificial intelligence model by assembling the AI modules based on the AI topology; and a training unit configured to train the candidate artificial intelligence model.

### CROSS-REFERENCE TO RELATED APPLICATION

This application claims the priority of the Korean Patent Applications NO 10-2023-0060729, filed on May 10, 2023, in the Korean Intellectual Property Office. The entire disclosures of all these applications are hereby incorporated by reference.

### BACKGROUND

### 1. Field

One or more embodiments relate to module-based artificial intelligence development tool and method for an adaptive autonomous agent, and more particularly, to a tool and method for assembling/developing artificial intelligence of an autonomous agent that adaptively responds to changes in the agent's environment, state, and purpose based on a module.

### 2. Description of the Related Art

Artificial intelligence is a core technology of an intelligent agent, showing excellent performance in various technical fields required by the intelligent agent, ranging from image processing, voice recognition, natural language processing, and robotics. Artificial intelligence technology may be applied to various actions of agents ranging from perception (cognition), reasoning, learning, decision-making, and action to support the achievement of more intelligent, high-level goals. For example, an intelligent agent of a smart building perceives (recognizes) images from CCTVs installed inside and outside the building and sensors of temperature/humidity and smoke, perceives (recognizes) the state of the building through signal processing AI, and learns and takes action appropriate to the recognized state through reinforcement learning.

Future agent technology is required to develop into an autonomous agent that can perform various purposes suitable for the user's needs by recognizing the surrounding environment and changes in its own state without human intervention (or with minimal help). However, due to the monolithic nature of current artificial intelligence technology, it is difficult to construct models suitable for the functions required by autonomous agents that adapt to changes in environment/state/purpose.

### DESCRIPTION OF EMBODIMENTS

### Technical Solution

As an embodiment of the present disclosure, a module-based prefabricated artificial intelligence development system may be provided.

The system according to an embodiment of the present disclosure may include: an adaptive artificial intelligence development unit; and an AI module hub, wherein the adaptive artificial intelligence development unit comprises: analysis unit configured to obtain adaptive autonomous agent requirement information and receive an AI topology and AI modules corresponding to the adaptive autonomous agent requirement information from the AI module hub; an assembly unit configured to generate a candidate artificial intelligence model by assembling the AI modules based on the AI topology; and a training unit configured to train the candidate artificial intelligence model.

the adaptive autonomous agent requirement information according to an embodiment of the present disclosure may include: at least one of environment information, state information, and purpose information for an adaptive autonomous agent.

The AI module hub according to an embodiment of the present disclosure may include: an AI topology storage, an AI module storage, an artificial intelligence modularization unit, and an artificial intelligence module profiler, the artificial intelligence modularization unit receives an artificial intelligence model, divides the artificial intelligence model into a plurality of modules, and stores structural information about the artificial intelligence model in the AI topology storage, and the artificial intelligence module profiler analyzes relevant information of each of the plurality of modules, generates profile information including related topology information, and input/output information, position, and characteristic information of the module, and stores the information in the AI module storage.

The artificial intelligence module profiler according to an embodiment of the present disclosure may generate meta information corresponding to each of the plurality of modules, and stores the plurality of modules and the meta information together in the AI module storage.

the analysis unit according to an embodiment of the present disclosure may receive the AI topology corresponding to the adaptive autonomous agent requirement information from the AI topology storage, and receives the AI modules corresponding to the adaptive autonomous agent requirement information from the AI module storage.

the training unit according to an embodiment of the present disclosure may evaluate a performance index of the candidate artificial intelligence model, and determines the candidate artificial intelligence model as a final artificial intelligence model based on a determination that the performance index exceeds a preset threshold, and evaluates a performance index of the candidate artificial intelligence model, stores the candidate artificial intelligence model together with the performance index based on a determination that the performance index is less than or equal to a preset threshold, and requests the assembly unit to generate a new candidate artificial intelligence model, and the assembly unit generates the new candidate artificial intelligence model in response to the requesting.

the training unit according to an embodiment of the present disclosure, when performance indices of a plurality of candidate artificial intelligence models generated by the assembly unit are all equal to or less than the preset threshold value, may determine a candidate artificial intelligence model having a highest performance index from among the plurality of candidate artificial intelligence models as a final artificial intelligence model.

### BRIEF DESCRIPTION OF THE DRAWINGS

FIG. 1 is views for explaining module-based prefabricated artificial intelligence development system according to an embodiment.

FIG. 2 is a view of a structure of an adaptive artificial intelligence development unit according to an embodiment.

FIG. 3 is a view for explaining a method of operating an adaptive artificial intelligence development unit according to an embodiment.

FIG. 4 is a view of a structure of an AI module hub according to an embodiment.

FIG. 5 is a view for explaining a method of operating an adaptive artificial intelligence development unit according to an embodiment.

FIG. 6 is a view of an example of an operation of a module-based prefabricated artificial intelligence development system according to an embodiment.

### DETAILED DESCRIPTION

Hereinafter, embodiments of the present invention will be described with reference to the drawings. In the following description, descriptions of a well-known technical configuration in relation to a lead implantation system for a deep brain stimulator will be omitted. For example, descriptions of the configuration/structure/method of a device or system commonly used in deep brain stimulation, such as the structure of an implantable pulse generator, a connection structure/method of the implantable pulse generator and a lead, and a process for transmitting and receiving electrical signals measured through the lead with an external device, will be omitted. Even if these descriptions are omitted, one of ordinary skill in the art will be able to easily understand the characteristic configuration of the present invention through the following description.

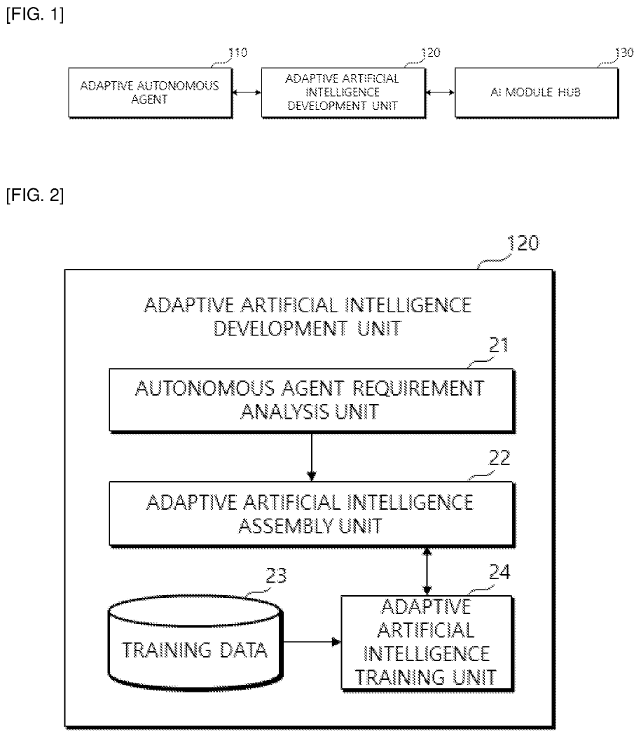

Referring to FIG. 1, a module-based prefabricated artificial intelligence development system according to an embodiment may include an adaptive autonomous agent 110, an adaptive artificial intelligence development unit 120, and an AI module hub 130 as subjects.

An agent according to an embodiment refers to an entity that perceives the surrounding environment using a sensor and takes appropriate actions through an actuator. The form of an agent encompasses a computing system or robot including software and hardware, and examples thereof include a disease diagnosis system, an artificial intelligence speaker, an autonomous vehicle, or a smart building.

With the development of IoT and artificial intelligence technologies, an agent has evolved into an intelligent agent that supports human decision-making by extracting meaningful knowledge from collected data beyond automating simple repetitive tasks, and further development into an autonomous agent that achieves a specific purpose autonomously through recognized information is expected.

Future agent technology is required to develop into an autonomous agent that can perform various purposes suitable for the user's needs by recognizing the surrounding environment and changes in its own state without human intervention (or with minimal help). However, due to the monolithic nature of current artificial intelligence technology, it is difficult to construct models suitable for the functions required by autonomous agents that adapt to changes in environment/state/purpose.

In more detail, an adaptive autonomous agent needs to be able to respond adaptively to changes in the surrounding environment and objectives. Taking a fire detection agent in a smart building as an example, high temperatures are common in summer, so an adaptive autonomous agent needs to set its fire detection criteria relatively high according to the weather (to detect fires at higher temperatures). Conversely, temperatures are generally lower in winter, so the adaptive autonomous agent needs to set its fire detection criteria relatively lower (to detect fires at lower temperatures). Another example is environmental changes in an autonomous vehicle. When an autonomous vehicle autonomously travels over a certain distance, it is necessary to respond adaptively to weather changes, road surface conditions, and regional changes (e.g., downtown, suburban or rural). In order to develop artificial intelligence that is adaptive to these environmental changes, it is necessary to secure data suitable for each situation. In general, it takes a lot of money and time to secure a large amount of training data in each situation. In addition, even if a large amount of training data is immediately obtained, a method of training an artificial intelligence model from the beginning has the disadvantage of slow learning convergence.

In addition, the adaptive autonomous agent needs to be able to show optimal performance in response to changes in its state. Sensors used by the adaptive autonomous agent may be additionally introduced, or some sensors in use may fail depending on circumstances. In this situation, an input form (e.g., sensor data) of an artificial intelligence model may change. In the existing monolithic artificial intelligence model, inputs and outputs are tightly coupled to each other, so performance degradation may occur because the existing monolithic artificial intelligence model cannot respond to changes in the input form. For example, when a fire detection agent using temperature, humidity, and gas sensors monitors a surrounding situation and fails to obtain correct gas sensor information due to network status and sensor errors and failures, the artificial intelligence model may operate only when arbitrary gas sensor data is injected as an input. In this case, performance may deteriorate due to misinterpretation of correlation between sensors. On the other hand, in order to introduce additional smoke sensors to improve the performance of a fire detection agent, it is necessary to redesign/redevelop/retrain an artificial intelligence model to receive a corresponding input.

In addition, the adaptive autonomous agent needs to be able to achieve new purposes according to user's requirements (e.g., added or changed requests) or functional requirements (e.g., added or changed requests) according to environment and state changes. In modern times, user's requirements for various services are changing every moment, and companies' efforts to respond to them are accelerating. Therefore, the adaptive autonomous agent needs to be able to add/change its own purpose according to these user's requirements. Functional requirements may be exemplified by autonomous drones. In the case of high flight of an autonomous drone, basic functions for movement to a simple way point, such as position estimation and attitude control, are required. On the other hand, for the purpose of low flight of an autonomous drone, functions for obstacle detection and avoidance are required in addition to the basic flight functions. In this way, user's requirements or functional requirements according to environment and state changes may change, but existing monolithic artificial intelligence models are very insufficient in scalability and flexibility to satisfy these requirements. A representative phenomenon of artificial intelligence models for these problems is a stability-plasticity dilemma. The stability-plasticity dilemma is a dilemma that arises when an artificial intelligence model trained for an existing purpose tries to train new data, and it is not easy to solve the dilemma because existing monolithic artificial intelligence models inevitably modify or change previously trained parameters to train new data.

As will be described in detail below, a module-based prefabricated artificial intelligence development system according to an embodiment may provide tools and methods for rapidly developing/applying artificial intelligence by modularizing artificial intelligence of an adaptive autonomous agent and assembling artificial intelligence suitable for requirements based on modules.

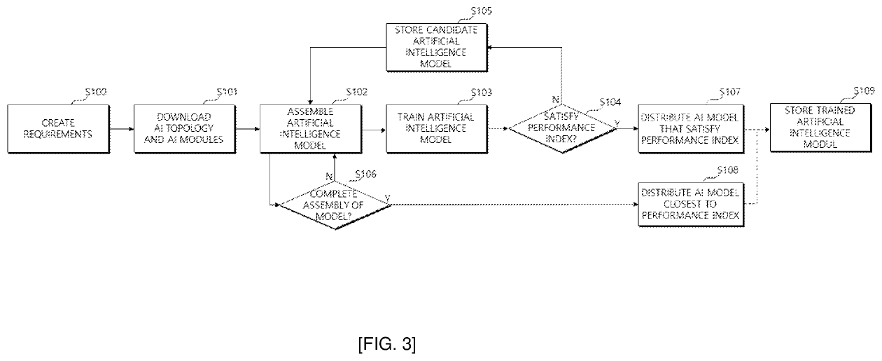

The adaptive artificial intelligence development unit 120 according to an embodiment may assemble and/or develop suitable artificial intelligence based on requirement information of the adaptive autonomous agent 110. The specific configuration and operation of the adaptive artificial intelligence development unit 120 will be described in detail with reference to FIGS. 2 and 3 below.

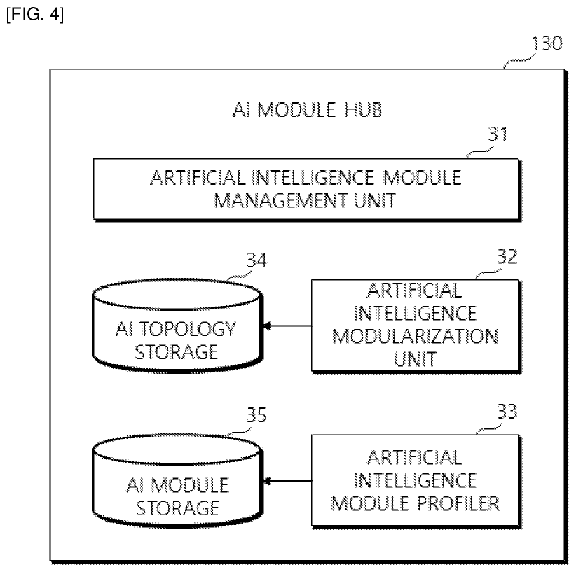

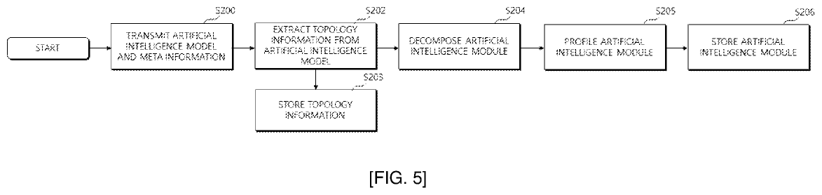

The AI module hub 130 according to an embodiment may modularize an artificial intelligence model to support development of adaptive artificial intelligence, and may provide storage, update, and search functions for a structure (hereafter a topology) and modules of artificial intelligence. The specific configuration and operation of the AI module hub 130 will be described in detail with reference to FIGS. 4 to 5 below.

FIG. 2 is a view of a structure of an adaptive artificial intelligence development unit according to an embodiment.

Referring to FIG. 2, the adaptive artificial intelligence development unit 120 according to an embodiment may include an autonomous agent requirement analysis unit 21, an adaptive artificial intelligence assembly unit 22, and an adaptive artificial intelligence training unit 24. However, the elements, shown in FIG. 2, are not essential elements. A multi-task learning model may be implemented by using more or less elements than those shown in FIG. 2. Terms such as “unit”, “er”, “or”, and the like described herein refer to units that perform at least one function or operation, and the units may be implemented as hardware or software or as a combination of hardware and software.

The adaptive artificial intelligence development unit 120 may quickly configure artificial intelligence required by a specific adaptive autonomous agent through communication with the AI module hub 130. The autonomous agent requirement analysis unit 21 according to an embodiment may select and download a topology and modules of an appropriate artificial intelligence model by analyzing requirement information including environment information, state information, and purpose information for an adaptive autonomous agent. Hereinafter, the adaptive artificial intelligence development unit 120 may be referred to as a development unit.

The adaptive artificial intelligence assembly unit 22 according to an embodiment may assemble artificial intelligence that satisfies requirements by utilizing the downloaded artificial intelligence topology and modules. Hereinafter, the adaptive artificial intelligence assembly unit 22 may be referred to as an assembly unit. According to the adaptive artificial intelligence assembly unit 22, as it is possible to easily plug & play artificial intelligence modules with various functions based on the artificial intelligence topology, artificial intelligence suitable for state changes of an adaptive autonomous agent may be developed and applied without human intervention (or with minimal intervention).

The adaptive artificial intelligence training unit 24 according to an embodiment may train an artificial intelligence model composed of a specific artificial intelligence topology structure and modules based on adaptive training data 23. Hereinafter, the adaptive artificial intelligence training unit 24 may be referred to as a training unit. The adaptive artificial intelligence training unit 24 enables the development of an artificial intelligence model that responds to additional purpose changes by selectively training only newly connected modules while minimally changing (or not changing) the existing part of the entire artificial intelligence model by flexibly connecting an additional artificial intelligence module to the existing module-based artificial intelligence model based on an artificial intelligence module, and through this, the adaptive artificial intelligence training unit 24 may support function expansion of the artificial intelligence models while avoiding a safety-plasticity dilemma problem.

In addition, an update of an artificial intelligence module in an artificial intelligence module hub for training results improves performance of the existing artificial intelligence module and supports functional differentiation for various purposes, and as a result, it is possible to maximize economic efficiency by improving performance of the entire artificial intelligence model and continuously reducing development time and cost.

FIG. 3 is a view for explaining a method of operating an adaptive artificial intelligence development unit according to an embodiment.

Details described with reference to FIGS. 1 and 2 may be equally applied to FIG. 3. Referring to FIG. 3, in operation S100, the adaptive autonomous agent 110 may create adaptive autonomous agent requirement information consisting of surrounding environment information recognized through a sensor, etc., execution state information of a sensor and an actuator, and purpose information including a function and a performance index required for the adaptive autonomous agent 110.

In operation S101, the autonomous agent requirement analysis unit 21 of the adaptive artificial intelligence development unit 120 may download a topology and modules that satisfy the created requirement information from an artificial intelligence topology and a module storage available in an AI module hub. Then, in operation S102, the adaptive artificial intelligence assembly unit 22 may assemble the downloaded models under the artificial intelligence topology.

In operation S103, the adaptive artificial intelligence training unit 24 may train the assembled artificial intelligence model by utilizing training data. At this time, when the configured artificial intelligence module does not satisfy the performance index of the purpose information in operation S104, in operation S105, the adaptive artificial intelligence training unit 24 may store the corresponding trained artificial intelligence model as a candidate artificial intelligence model along with performance information. The adaptive artificial intelligence training unit 24 may request the adaptive artificial intelligence assembly unit 22 again to assemble another type of artificial intelligence module, and may repeat the process until a target performance index is satisfied under the downloaded topology and modules (operations S102-S103-S104-S105).

In operation S107, when a finally trained artificial intelligence module satisfies the target performance index, the adaptive artificial intelligence training unit 24 may transmit the artificial intelligence model to the adaptive autonomous agent 110. In operation S106, when the performance index is not satisfied even after completing the assembly of the artificial intelligence model for all cases under the downloaded topology and modules, and in operation S108, the adaptive artificial intelligence training unit 24 may transmit an artificial intelligence model closest to the target performance index from among stored candidate artificial intelligence models to the adaptive autonomous agent 110. In operation S109, each module of an artificial intelligence model to be finally distributed may be stored through the AI module hub depending on whether it is reused or not.

FIG. 4 is a view of a structure of an AI module hub according to an embodiment.

Referring to FIG. 4, the AI module hub 130 according to an embodiment may include an artificial intelligence module management unit 31, an artificial intelligence modularization unit 32, an artificial intelligence module profiler 33, an AI topology storage 34, and an AI module storage 35. However, the elements, shown in FIG. 4, are not essential elements. A multi-task learning model may be implemented by using more or less elements than those shown in FIG. 4. Terms such as “unit”, “er”, “or”, and the like described herein refer to units that perform at least one function or operation, and the units may be implemented as hardware or software or as a combination of hardware and software.

The AI module hub 130 according to an embodiment may modularize an artificial intelligence model and manage structural information and modules of artificial intelligence to flexibly and appropriately utilize an artificial intelligence model 14 developed for various purposes according to changes in environment, status, and purpose.

The artificial intelligence module management unit 31 according to an embodiment may perform storage/retrieval/update/delete of an artificial intelligence topology and module information. In more detail, the artificial intelligence module management unit 31 may receive autonomous agent requirements from the adaptive artificial intelligence development unit 120 and may search and extract an artificial intelligence topology and module information corresponding to the autonomous agent requirements.

The artificial intelligence modularization unit 32 according to an embodiment may separate a pre-prepared artificial intelligence model into each module and store structural information about the artificial intelligence model in the AI topology storage 34.

The artificial intelligence module profiler 33 according to an embodiment may analyze relevant information of each artificial intelligence module to generate profile information including related topology information, and input/output information, position, and characteristic information of the module, and may store the profile information in the AI module storage 35.

The AI module hub 130 according to an embodiment may support easy and fast development of an artificial intelligence model that supports various functions of an adaptive autonomous agent by managing/sharing an artificial intelligence topology and modules in the form of a library. The AI module hub 130 may take advantage of generalization capability improvement and fast learning convergence through module-level transfer learning using pre-trained modules.

FIG. 5 is a view for explaining a method of operating an adaptive artificial intelligence development unit according to an embodiment.

Details described with reference to FIGS. 1 to 4 may be equally applied to FIG. 5. Referring to FIG. 5, the AI module hub 130 according to an embodiment may store and manage an artificial intelligence topology and modules.

First, in operation S200, the AI module hub 130 may transmit an artificial intelligence model developed for various purposes to the artificial intelligence module management unit 31 of the AI module hub 130 along with meta information describing the model.

Artificial intelligence meta information may include classification categories (e.g., image classification, object recognition, speaker recognition, natural language processing, etc.), titles, and description texts of the artificial intelligence model.

In operation S202, the artificial intelligence modularization unit 32 may extract topology information from the received artificial intelligence model, and in operation S203, may store the topology information in the artificial intelligence topology storage 34.

In operation S204, the artificial intelligence modularization unit 32 may also decompose each module under a corresponding artificial intelligence topology. At this time, each module may include layers, building blocks, modules, etc. constituting the artificial intelligence model.

Thereafter, in operation S205, the artificial intelligence module profiler 33 may generate artificial intelligence module meta information including a description of each module, and in operation S206, may finally store each module and meta information together in the artificial intelligence topology storage 34. Meta information about a module may include position information about where the module is located in an artificial intelligence topology, input/output information of the module, characteristics of the module, and the like.

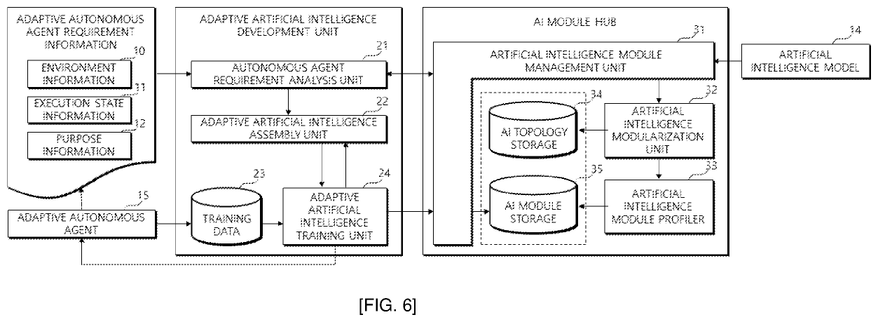

FIG. 6 is a view of an example of an operation of a module-based prefabricated artificial intelligence development system according to an embodiment.

Details described with reference to FIGS. 1 and 5 may be equally applied to FIG. 6. Referring to FIG. 6, the adaptive autonomous agent 15 may create adaptive autonomous agent requirement information consisting of environment information 10 recognized through a sensor, etc., execution state information 11 of a sensor and an actuator, and purpose information 12 including a function and a performance index required for the adaptive autonomous agent 15.

The adaptive artificial intelligence development unit may obtain adaptive autonomous agent requirement information and receive an AI topology and AI modules corresponding to the adaptive autonomous agent requirement information from an AI module hub. In more detail, in operation S101, the autonomous agent requirement analysis unit 21 may download a topology and modules satisfying written requirements from the AI topology storage 34 and the AI module storage 35 available in the AI module hub.

Because the AI topology storage 34 and the AI module storage 35 store meta information corresponding to them together, the artificial intelligence module management unit 31 may compare requirements with meta information and provide a topology and modules satisfying the requirements to the autonomous agent requirement analysis unit 21.

In more detail, the AI topology storage 34 may store an artificial intelligence model and artificial intelligence meta information corresponding to the artificial intelligence model. The artificial intelligence meta information may include classification categories (e.g., image classification, object recognition, speaker recognition, natural language processing, etc.), titles, and description texts of the artificial intelligence model. The artificial intelligence module management unit 31 may extract artificial intelligence models capable of processing the environment information 10, the execution state information 11, and the purpose information 12 by referring to the artificial intelligence meta information. For example, the artificial intelligence module management unit 31 may receive the environment information 10, the execution state information 11, and the purpose information 12, and may include an artificial intelligence model trained to extract an artificial intelligence model most suitable for the environment information 10, the execution state information 11, and the purpose information 12.

The adaptive artificial intelligence assembly unit 22 may assemble the downloaded modules under the artificial intelligence topology, and the adaptive artificial intelligence training unit 24 may train the assembled artificial intelligence model using the adaptive training data 23.

The embodiments described above may be implemented by hardware components, software components, and/or any combination thereof. For example, the devices, the methods, and components described in the embodiments may be implemented by using general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other devices which may execute and respond to instructions. A processing apparatus may execute an operating system (OS) and a software application executed in the OS. Also, the processing apparatus may access, store, operate, process, and generate data in response to the execution of software. For convenience of understanding, it may be described that one processing apparatus is used. However, one of ordinary skill in the art will understand that the processing apparatus may include a plurality of processing elements and/or various types of processing elements. For example, the processing apparatus may include a plurality of processors or a processor and a controller. Also, other processing configurations, such as a parallel processor, are also possible.

The software may include computer programs, code, instructions, or any combination thereof, and may construct the processing apparatus for desired operations or may independently or collectively command the processing apparatus. In order to be interpreted by the processing apparatus or to provide commands or data to the processing apparatus, the software and/or data may be permanently or temporarily embodied in any types of machines, components, physical devices, virtual equipment, computer storage mediums, or transmitted signal waves. The software may be distributed over network coupled computer systems so that it may be stored and executed in a distributed fashion. The software and/or data may be recorded in a computer-readable recording medium.

A method according to an embodiment may be implemented as program instructions that can be executed by various computer devices, and recorded on a computer-readable recording medium. The computer-readable recording medium may include program instructions, data files, data structures or a combination thereof. Program instructions recorded on the medium may be particularly designed and structured for embodiments or available to one of ordinary skill in a field of computer software. Examples of the computer-readable recording medium include magnetic media, such as a hard disc, a floppy disc, and magnetic tape; optical media, such as a compact disc-read only memory (CD-ROM) and a digital versatile disc (DVD); magneto-optical media, such as floptical discs; and hardware devices specially configured to store and execute program instructions, such as ROM, random-access memory (RAM), a flash memory, etc. Program instructions may include, for example, high-level language code that can be executed by a computer using an interpreter, as well as machine language code made by a complier.

In concluding the detailed description, those skilled in the art will appreciate that many variations and modifications may be made to the preferred embodiments without substantially departing from the principles of the present invention. Therefore, the disclosed preferred embodiments of the invention are used in a generic and descriptive sense only and not for purposes of limitation.

What is claimed is:

1. A module-based prefabricated artificial intelligence development system comprising:
an adaptive artificial intelligence development unit; and
an AI module hub,
wherein the adaptive artificial intelligence development unit comprises:
analysis unit configured to obtain adaptive autonomous agent requirement information and receive an AI topology and AI modules corresponding to the adaptive autonomous agent requirement information from the AI module hub;
an assembly unit configured to generate a candidate artificial intelligence model by assembling the AI modules based on the AI topology; and
a training unit configured to train the candidate artificial intelligence model.

2. The module-based prefabricated artificial intelligence development system of claim 1, wherein the adaptive autonomous agent requirement information comprises at least one of environment information, state information, and purpose information for an adaptive autonomous agent.

3. The module-based prefabricated artificial intelligence development system of claim 1, wherein the AI module hub comprises an AI topology storage, an AI module storage, an artificial intelligence modularization unit, and an artificial intelligence module profiler,
the artificial intelligence modularization unit receives an artificial intelligence model, divides the artificial intelligence model into a plurality of modules, and stores structural information about the artificial intelligence model in the AI topology storage, and
the artificial intelligence module profiler analyzes relevant information of each of the plurality of modules, generates profile information including related topology information, and input/output information, position, and characteristic information of the module, and stores the information in the AI module storage.

4. The module-based prefabricated artificial intelligence development system of claim 3, wherein the artificial intelligence module profiler generates meta information corresponding to each of the plurality of modules, and stores the plurality of modules and the meta information together in the AI module storage.

5. The module-based prefabricated artificial intelligence development system of claim 3, wherein the analysis unit receives the AI topology corresponding to the adaptive autonomous agent requirement information from the AI topology storage, and receives the AI modules corresponding to the adaptive autonomous agent requirement information from the AI module storage.

6. The module-based prefabricated artificial intelligence development system of claim 1, wherein the training unit evaluates a performance index of the candidate artificial intelligence model, and determines the candidate artificial intelligence model as a final artificial intelligence model based on a determination that the performance index exceeds a preset threshold, and
evaluates a performance index of the candidate artificial intelligence model, stores the candidate artificial intelligence model together with the performance index based on a determination that the performance index is less than or equal to a preset threshold, and requests the assembly unit to generate a new candidate artificial intelligence model, and
the assembly unit generates the new candidate artificial intelligence model in response to the requesting.

7. The module-based prefabricated artificial intelligence development system of claim 6, wherein the training unit, when performance indices of a plurality of candidate artificial intelligence models generated by the assembly unit are all equal to or less than the preset threshold value, determines a candidate artificial intelligence model having a highest performance index from among the plurality of candidate artificial intelligence models as a final artificial intelligence model.
